(19) United States
(12) Patent Application Publication
(10) Pub. No.: US 2020/0145889 A1
(43) Pub. Date: May 7, 2020

(54) SYSTEMS AND METHODS FOR NEW RADIO MOBILITY

(71) Applicants: Sharp Kabushiki Kaisha, Sakai City, Osaka (JP); FG Innovation Company Limited, Tuen Mun, New Territories (HK)

(72) Inventor: Shohei YAMADA, Sakai City (JP)

(21) Appl. No.: 16/473,293

(22) PCT Filed: Dec. 28, 2017
(86) PCT No.: PCT/JP2017/047206

§ 371 Date: Jun. 25, 2019

Related U.S. Application Data
(60) Provisional application No. 62/440,425, filed on Dec. 30, 2016.

(51) Int. Cl. H04W 36/00; H04W 36/36; H04W 76/27; H04W 80/02

(52) U.S. Cl. CPC H04W 36/00837; H04W 36/0007; H04W 80/02; H04W 76/27; H04W 36/36

(57) ABSTRACT

A method by a user equipment (UE) is described. The method includes receiving, from a base station, a radio resource control (RRC) message including one or more RRC parameters, wherein the one or more RRC parameters include parameters related to a cell reselection, and the RRC message is sent on a dedicated control channel (DCCH) logical channel; and performing a cell reselection procedure in response to receive the one or more RRC parameters.

### CROSS REFERENCE

This Nonprovisional application claims priority under 35 U.S.C. § 119 on provisional Application No. 62/440,425 on Dec. 30, 2016, the entire contents of which are hereby incorporated by reference.

### TECHNICAL FIELD

The present disclosure relates generally to communication systems. More specifically, the present disclosure relates to systems and methods for New Radio mobility.

### BACKGROUND ART

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility, low complexity and efficiency have been sought. However, improving communication capacity, speed, flexibility, low complexity and efficiency may present certain problems.

For example, wireless communication devices may communicate with one or more devices using multiple connections. However, the multiple connections may only offer limited flexibility and efficiency. As illustrated by this discussion, systems and methods that improve communication flexibility and efficiency may be beneficial.

### SUMMARY OF INVENTION

One embodiment of the present invention discloses a method by a user equipment (UE), comprising: receiving, from a base station, a radio resource control (RRC) message including one or more RRC parameters, wherein the one or more RRC parameters include parameters related to a cell reselection, and the RRC message is sent on a dedicated control channel (DCCH) logical channel; and performing a cell reselection procedure in response to receive the one or more RRC parameters.

Another one embodiment of the present invention discloses a method by a base station, comprising: broadcasting system information including parameters related to a cell reselection; and transmitting, to a user equipment (UE), a radio resource control (RRC) message including one or more RRC parameters, wherein the one or more RRC parameters include parameters related to a cell reselection; the RRC message is sent on a dedicated control channel (DCCH) logical channel, and the one or more RRC parameter causes the UE to perform a cell reselection procedure.

Yet another one embodiment of the present invention discloses a user equipment (UE), comprising: a processor; and memory in electronic communication with the processor, wherein instructions stored in the memory are executable to: receive, from a base station, a radio resource control (RRC) message including one or more RRC parameters, wherein the one or more RRC parameters include parameters related to a cell reselection; the RRC message is sent on a dedicated control channel (DCCH) logical channel; and perform a cell reselection procedure in response to receive the one or more RRC parameters.

Yet another one embodiment of the present invention discloses a base station, comprising: a processor; and memory in electronic communication with the processor, wherein instructions stored in the memory are executable to: broadcast system information including parameters related to a cell reselection; and transmit, to a user equipment (UE), a radio resource control (RRC) message including one or more RRC parameters, wherein the one or more RRC parameters include parameters related to a cell reselection; the RRC message is sent on a dedicated control channel (DCCH) logical channel, and the one or more RRC parameter causes the UE to perform a cell reselection procedure.

### BRIEF DESCRIPTION OF DRAWINGS

FIG. 1 is a block diagram illustrating one configuration of one or more gNBs and one or more user equipments (UEs) in which systems and methods for New Radio mobility may be implemented;

FIG. 2 is a flow diagram illustrating one implementation of a method for New Radio mobility by a UE;

FIG. 3 is a flow diagram illustrating one implementation of a method for New Radio mobility by a gNB;

FIG. 4 illustrates various components that may be utilized in a UE;

FIG. 5 illustrates various components that may be utilized in a gNB;

### DESCRIPTION OF EMBODIMENTS

A method by a user equipment (UE) is described. The method includes receiving, from a base station, a radio resource control (RRC) message including one or more RRC parameters. The one or more RRC parameters include parameters related to a cell reselection, and the RRC message is sent on a dedicated control channel (DCCH) logical channel. The method further includes performing a cell reselection procedure in response to receive the one or more RRC parameters.

A method by a base station is described. The method includes broadcasting system information including parameters related to cell reselection, and transmitting, to a user equipment (UE), a radio resource control (RRC) message including one or more RRC parameters. The one or more RRC parameters include parameters related to a cell reselection; the RRC message is sent on a dedicated control channel (DCCH) logical channel, and the one or more RRC parameter causes the UE to perform a cell reselection procedure.

A user equipment (UE) is described. The UE includes a processor and memory in electronic communication with the processor. Instructions stored in the memory are executable to receive, from a base station, a radio resource control (RRC) message including one or more RRC parameters. The one or more RRC parameters include parameters related to a cell reselection and the RRC message is sent on a dedicated control channel (DCCH) logical channel. The instructions stored in the memory are executable to receive perform a cell reselection procedure in response to receive the one or more RRC parameters.

A base station is described. The base station includes a processor and memory in electronic communication with the processor. Instructions stored in the memory are executable to broadcast system information including parameters related to a cell reselection, and transmit, to a user equipment (UE), a radio resource control (RRC) message including one or more RRC parameters. The one or more RRC parameters include parameters related to a cell reselection, the RRC message is sent on a dedicated control channel (DCCH) logical channel, and the one or more RRC parameter causes the UE to perform a cell reselection procedure.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN). 3GPP NR (New Radio) is the name given to a project to improve the LTE mobile phone or device standard to cope with future requirements. In one aspect, LTE has been modified to provide support and specification for the New Radio Access (NR) and 5th generation-Radio Access Network (5G-RAN).

At least some aspects of the systems and methods disclosed herein may be described in relation to the 3GPP LTE, LTE-Advanced (LTE-A), LTE-Advanced Pro, New Radio Access (NR), and other standards (e.g., 3GPP Releases 8, 9, 10, 11, 12, 13, and/or 14, and/or Narrow Band-Internet of Things (NB-IoT)). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE (User Equipment), an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”.

In 3GPP specifications, a base station is typically referred to as a gNB, a Node B, an eNB, a home enhanced or evolved Node B (HeNB) or some other similar terminology. As the scope of the disclosure should not be limited to 3GPP standards, the terms “base station,”, “gNB”, “Node B,” “eNB,” and “HeNB” may be used interchangeably herein to mean the more general term “base station.” Furthermore, one example of a “base station” is an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced), IMT-2020 (5G) and all of it or a subset of it may be adopted by 3GPP as licensed bands (e.g., frequency bands) to be used for communication between a gNB and a UE. It should also be noted that in NR, 5G-RAN, E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by a gNB to transmit or receive information. “Configured cell(s)” may be serving cell(s). The UE may receive system information and perform the required measurements on configured cells. “Configured cell(s)” for a radio connection may consist of a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDCCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The gNBs may be connected by the NG interface to the 5G-core network (5G-CN). 5G-CN may be called as to NextGen core (NGC), or 5G core (5GC). The gNBs may also be connected by the S1 interface to the evolved packet core (EPC). For instance, the gNBs may be connected to a NextGen (NG) mobility management function by the NG-2 interface and to the NG core User Plane (UP) functions by the NG-3 interface. The NG interface supports a many-to-many relation between NG mobility management functions, NG core UP functions and the gNBs. The NG-2 interface is the NG interface for the control plane and the NG-3 interface is the NG interface for the user plane. For instance for EPC connection, the gNBs may be connected to a mobility management entity (MME) by the S1-MME interface and to the serving gateway (S-GW) by the S1-U interface. The S1 interface supports a many-to-many relation between MMEs, serving gateways and the gNBs. The S1-MME interface is the S1 interface for the control plane and the S1-U interface is the Si interface for the user plane. The Uu interface is a radio interface between the UE and the gNB for the radio protocol of 5G-RAN.

The radio protocol architecture of 5G-RAN may include the user plane and the control plane. The user plane protocol stack may include packet data convergence protocol (PDCP), radio link control (RLC), medium access control (MAC) and physical (PHY) layers. A DRB (Data Radio Bearer) is a radio bearer that carries user data (as opposed to control plane signaling). For example, a DRB may be mapped to the user plane protocol stack. The PDCP, RLC, MAC and PHY sublayers (terminated at the gNB 460a on the network) may perform functions (e.g., header compression, ciphering, scheduling, ARQ and HARQ) for the user plane. PDCP entities are located in the PDCP sublayer. RLC entities may be located in the RLC sublayer. MAC entities may be located in the MAC sublayer. The PHY entities may be located in the PHY sublayer.

The control plane may include a control plane protocol stack. The PDCP sublayer (terminated in gNB on the network side) may perform functions (e.g., ciphering and integrity protection) for the control plane. The RLC and MAC sublayers (terminated in gNB on the network side) may perform the same functions as for the user plane. The Radio Resource Control (RRC) (terminated in gNB on the network side) may perform the following functions. The RRC may perform broadcast functions, paging, RRC connection management, radio bearer (RB) control, mobility functions, UE measurement reporting and control. The Non-Access Stratum (NAS) control protocol (terminated in MME on the network side) may perform, among other things, evolved packet system (EPS) bearer management, authentication, evolved packet system connection management (ECM)-IDLE mobility handling, paging origination in ECM-IDLE and security control.

Signaling Radio Bearers (SRBs) are Radio Bearers (RB) that may be used only for the transmission of RRC and NAS messages. Three SRBs may be defined. SRBO may be used for RRC messages using the common control channel (CCCH) logical channel. SRB1 may be used for RRC messages (which may include a piggybacked NAS message) as well as for NAS messages prior to the establishment of SRB2, all using the dedicated control channel (DCCH) logical channel. SRB2 may be used for RRC messages which include logged measurement information as well as for NAS messages, all using the DCCH logical channel. SRB2 has a lower-priority than SRB1 and may be configured by 5G-RAN (e.g., gNB) after security activation. A broadcast control channel (BCCH) logical channel may be used for broadcasting system information. Some of BCCH logical channel may convey system information which may be sent from the 5GRAN to the UE via BCH (Broadcast Channel) transport channel. Some of BCCH logical channel may convey system information which may be sent from the 5G-RAN to the UE via DL-SCH (Downlink Shared Channel) transport channel. Paging may be provided by using paging control channel (PCCH) logical channel.

For example, the DL-DCCH logical channel may be used (but not limited to) for a RRC connection reconfiguration message, a RRC connection reestablishment message, a RRC connection release, a UE Capability Enquiry message, a DL Information Transfer message or a Security Mode Command message. UL-DCCH logical channel may be used (but not limited to) for a measurement report message, a RRC Connection Reconfiguration Complete message, a RRC Connection Reestablishment Complete message, a RRC Connection Setup Complete message, a Security Mode Complete message, a Security Mode Failure message, a UE Capability Information, message, a UL Handover Preparation Transfer message, a UL Information Transfer message, a Counter Check Response message, a UE Information Response message, a Proximity Indication message, a RN (Relay Node) Reconfiguration Complete message, an MBMS Counting Response message, an inter Frequency RSTD Measurement Indication message, a UE Assistance Information message, an In-device Coexistence Indication message, an MBMS Interest Indication message, an SCG Failure Information message. DL-CCCH logical channel may be used (but not limited to) for a RRC Connection Reestablishment message, a RRC Connection Reestablishment Reject message, a RRC Connection Reject message, or a RRC Connection Setup message. UL-CCCH logical channel may be used (but not limited to) for a RRC Connection Reestablishment Request message, or a RRC Connection Request message.

System information may be divided into the MasterInformationBlock (MIB) and a number of SystemInformationBlocks (SIBs).

The UE may receive one or more RRC messages from the gNB to obtain RRC configurations or parameters. The RRC layer of the UE may configure RRC layer and/or lower layers (e.g., PHY layer, MAC layer, RLC layer, PDCP layer) of the UE according to the RRC configurations or parameters which may be configured by the RRC messages, broadcasted system information, and so on. The gNB may transmit one or more RRC messages to the UE to cause the UE to configure RRC layer and/or lower layers of the UE according to the RRC configurations or parameters which may be configured by the RRC messages, broadcasted system information, and so on.

When carrier aggregation is configured, the UE may have one RRC connection with the network. One radio interface may provide carrier aggregation. During RRC connection establishment, re-establishment and handover, one serving cell may provide Non-Access Stratum (NAS) mobility information (e.g., a tracking area identity (TAI)). During RRC connection re-establishment and handover, one serving cell may provide a security input. This cell may be referred to as the primary cell (PCell). In the downlink, the component carrier corresponding to the PCell may be the downlink primary component carrier (DL PCC), while in the uplink it may be the uplink primary component carrier (UL PCC).

Depending on UE capabilities, one or more SCells may be configured to form together with the PCell a set of serving cells. In the downlink, the component carrier corresponding to an SCell may be a downlink secondary component carrier (DL SCC), while in the uplink it may be an uplink secondary component carrier (UL SCC).

The configured set of serving cells for the UE, therefore, may consist of one PCell and one or more SCells. For each SCell, the usage of uplink resources by the UE (in addition to the downlink resources) may be configurable. The number of DL SCCs configured may be larger than or equal to the number of UL SCCs and no SCell may be configured for usage of uplink resources only.

From a UE viewpoint, each uplink resource may belong to one serving cell. The number of serving cells that may be configured depends on the aggregation capability of the UE. The PCell may only be changed using a handover procedure (e.g., with a security key change and a random access procedure). A PCell may be used for transmission of the PUCCH. A primary secondary cell (PSCell) may also be used for transmission of the PUCCH. The PCell or PSCell may not be de-activated. Reestablishment may be triggered when the PCell experiences radio link failure (RLF), not when the SCells experience RLF. Furthermore, NAS information may be taken from the PCell.

The reconfiguration, addition and removal of SCells may be performed by RRC. At intra-LTE handover, Radio Resource Control (RRC) layer may also add, remove or reconfigure SCells for usage with a target PCell. When adding a new SCell, dedicated RRC signaling may be used for sending all required system information of the SCell (e.g., while in connected mode, UEs need not acquire broadcasted system information directly from the SCells).

The systems and methods described herein may enhance the efficient use of radio resources in Carrier aggregation (CA) operation. Carrier aggregation refers to the concurrent utilization of more than one component carrier (CC). In carrier aggregation, more than one cell may be aggregated to a UE. In one example, carrier aggregation may be used to increase the effective bandwidth available to a UE. In traditional carrier aggregation, a single gNB is assumed to provide multiple serving cells for a UE. Even in scenarios where two or more cells may be aggregated (e.g., a macro cell aggregated with remote radio head (RRH) cells) the cells may be controlled (e.g., scheduled) by a single gNB.

The systems and methods described herein may enhance the efficient use of radio resources in Carrier aggregation operation. Carrier aggregation refers to the concurrent utilization of more than one component carrier (CC). In carrier aggregation, more than one cell may be aggregated to a UE. In one example, carrier aggregation may be used to increase the effective bandwidth available to a UE. In traditional carrier aggregation, a single gNB is assumed to provide multiple serving cells for a UE. Even in scenarios where two or more cells may be aggregated (e.g., a macro cell aggregated with remote radio head (RRH) cells) the cells may be controlled (e.g., scheduled) by a single gNB. However, in a small cell deployment scenario, each node (e.g., gNB, RRH, etc.) may have its own independent scheduler. To maximize the efficiency of radio resources utilization of both nodes, a UE may connect to two or more nodes that have different schedulers. The systems and methods described herein may enhance the efficient use of radio resources in dual connectivity operation. A UE may be configured multiple groups of serving cells, where each group may have carrier aggregation operation (e.g., if the group includes more than one serving cell).

In Dual Connectivity (DC) the UE may be required to be capable of UL-CA with simultaneous PUCCH/PUCCH and PUCCH/PUSCH transmissions across cell-groups (CGs). In a small cell deployment scenario, each node (e.g., eNB, RRH, etc.) may have its own independent scheduler. To maximize the efficiency of radio resources utilization of both nodes, a UE may connect to two or more nodes that have different schedulers. A UE may be configured multiple groups of serving cells, where each group may have carrier aggregation operation (e.g., if the group includes more than one serving cell). A UE in RRC CONNECTED may be configured with Dual Connectivity, when configured with a Master and a Secondary Cell Group. A Cell Group (CG) may be a subset of the serving cells of a UE, configured with Dual Connectivity (DC), i.e. a Master Cell Group (MCG) or a Secondary Cell Group (SCG). The Master Cell Group may be a group of serving cells of a UE comprising of the PCell and zero or more secondary cells. The Secondary Cell Group (SCG) may be a group of secondary cells of a UE, configured with DC, comprising of the PSCell and zero or more other secondary cells. A Primary Secondary Cell (PSCell) may be the SCG cell in which the UE is instructed to perform random access when performing the SCG change procedure. In Dual Connectivity, two MAC entities may be configured in the UE: one for the MCG and one for the SCG. Each MAC entity may be configured by RRC with a serving cell supporting PUCCH transmission and contention based Random Access. In a MAC layer, the term Special Cell (SpCell) may refer to such cell, whereas the term SCell may refer to other serving cells. The term SpCell either may refer to the PCell of the MCG or the PSCell of the SCG depending on if the MAC entity is associated to the MCG or the SCG, respectively. A Timing Advance Group (TAG) containing the SpCell of a MAC entity may be referred to as primary TAG (pTAG), whereas the term secondary TAG (sTAG) refers to other TAGs.

A timer is running once it is started, until it is stopped or until it expires; otherwise it is not running A timer can be started if it is not running or restarted if it is running A Timer may be always started or restarted from its initial value.

To support tight interworking between LTE and NR, a technology of aggregating data flows between the two radio access technologies (RATs) may be studied based on Dual Connectivity (DC) for LTE. In DC between LTE and NR, both LTE eNB and NR gNB can act as a master node.

For NR, a technology of aggregating NR carriers may be studied. Both lower layer aggregation like Carrier Aggregation (CA) for LTE and upper layer aggregation like DC are investigated. From layer 2/3 point of view, aggregation of carriers with different numerologies may be supported in NR. Modeling aspects such as whether it is a single or multiple MAC entity may be further studied.

The main services and functions of the RRC sublayer may include the following:
Broadcast of System Information related to Access Stratum (AS) and Non Access Stratum (NAS);
Paging initiated by CN or RAN;
Establishment, maintenance and release of an RRC connection between the UE and NR RAN including:
Addition, modification and release of carrier aggregation;
Addition, modification and release of Dual Connectivity in NR or between LTE and NR;
Security functions including key management;
Establishment, configuration, maintenance and release of signaling radio bearers and data radio bearers;
Mobility functions including:
Handover;
UE cell selection and reselection and control of cell selection and reselection;
Context transfer at handover.
QoS management functions;
UE measurement reporting and control of the reporting;
NAS message transfer to/from NAS from/to UE.

Instead of fully network controlled mobility (e.g., normal handover), some kind of UE controlled mobility may be introduced in NR system and method described herein. In NR, RRC_INACTIVE state may be added to RRC_IDLE state and RRC_CONNECTED state. RRC_IDLE may be characterized as cell re-selection mobility, paging initiated by core network (CN), and/or paging area managed by CN. RRC_CONNECTED may be characterized as the UE has an NR RRC connection, the UE has an AS (Access Stratum) context in NR, 5G-RAN knows the cell which the UE belongs to, Transfer of unicast data to/from the UE is supported, and/or Network controlled mobility (i.e. handover within NR and to/from E-UTRAN). RRC_INACTIVE may be characterized as Cell re-selection mobility is supported, CN-5G-RAN connection (both C/U-planes) has been established for UE, the UE AS context is stored in at least one gNB and the UE, Notification is initiated by 5G-RAN, RAN-based notification area is managed by 5G-RAN, and/or 5G-RAN knows the RAN-based notification area which the UE belongs to.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

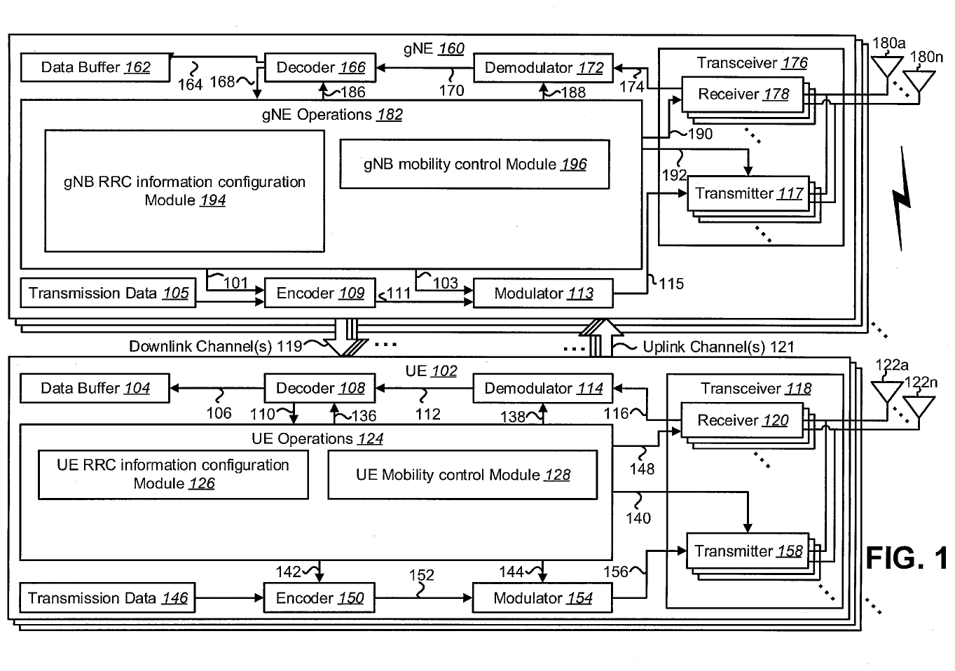

FIG. 1 is a block diagram illustrating one configuration of one or more gNBs 160 (e.g., eNB, gNB) and one or more user equipments (UEs) 102 in which systems and methods for New Radio mobility may be implemented. The one or more UEs 102 may communicate with one or more gNBs 160 using one or more antennas 122a-n. For example, a UE 102 transmits electromagnetic signals to the gNB 160 and receives electromagnetic signals from the gNB 160 using the one or more antennas 122a-n. The gNB 160 communicates with the UE 102 using one or more antennas 180a-n.

It should be noted that in some configurations, one or more of the UEs 102 described herein may be implemented in a single device. For example, multiple UEs 102 may be combined into a single device in some implementations. Additionally or alternatively, in some configurations, one or more of the gNBs 160 described herein may be implemented in a single device. For example, multiple gNBs 160 may be combined into a single device in some implementations. In the context of FIG. 1, for instance, a single device may include one or more UEs 102 in accordance with the systems and methods described herein. Additionally or alternatively, one or more gNBs 160 in accordance with the systems and methods described herein may be implemented as a single device or multiple devices.

The UE 102 and the gNB 160 may use one or more channels 119, 121 to communicate with each other. For example, a UE 102 may transmit information or data to the gNB 160 using one or more uplink channels 121 and signals. Examples of uplink channels 121 include a physical uplink control channel (PUCCH) and a physical uplink shared channel (PUSCH), etc. Examples of uplink signals include a demodulation reference signal (DMRS) and a sounding reference signal (SRS), etc. The one or more gNBs 160 may also transmit information or data to the one or more UEs 102 using one or more downlink channels 119 and signals, for instance. Examples of downlink channels 119 include a PDCCH, a PDSCH, etc. Examples of downlink signals include a primary synchronization signal (PSS), a secondary synchronization signal (SSS), a cell-specific reference signal (CRS), and a channel state information (CSI) reference signal (CSI-RS), etc. Other kinds of channels or signals may be used.

The size of various fields in the time domain may be expressed as a number of time units

Tₛ=1/(15000×2048)

seconds. Downlink, uplink and sidelink transmissions are organized into radio frames with

T_{f}=307200×Tₛ=10 ms

duration. Three radio frame structures may be supported: Type 1, applicable to FDD, Type 2, applicable to TDD, Type 3, applicable to License Assisted Access (LAA). Frame structure type 1 may be applicable to both full duplex and half duplex FDD. Each radio frame is

T_{f}=307200·Tₛ=10 ms

long and consists of 20 slots of length

Tₛₗₒₜ=15360·Tₛ=0.5 ms

numbered from 0 to 19. A subframe may be defined as two consecutive slots where subframe i consists of slots 2i and 2i+1. For frame structure type 2, each radio frame of length

T_{f}=307200·Tₛ=10 ms

may consist of two half-frames of length

153600·Tₛ=5 ms

each. Each half-frame may consist of five subframes of length

30720·Tₛ=1 ms

Each subframe i may be defined as two slots, 2i and 2i+1, of length

Tₛₗₒₜ=15360·Tₛ=0.5 ms

each. In NR, multiple numerologies may be supported.

A normal handover operation may be based on handover (HO) command (i.e., RRC Connection Reconfiguration message with mobility control information) which include a cell identity (e.g., a physical cell identity of a target cell) and random access parameters to access a target cell in response to receive the HO command. In addition to a normal handover operation, UE determination of a handover trigger based on a configured condition after HO command is provided may be supported in NR. It may allow the UE to determine a timing of access to the target cell while only one target cell is assumed.

In one implementation, the UE may receive, from the gNB, a RRC message including one or more RRC parameters. The one or more RRC parameters may include parameters related to a condition. The condition may be related to a handover, triggering a handover, a timing that the UE starts a timer related to a handover failure (e.g., T304), a timing that the UE starts synchronizing to the downlink of the target cell, and/or a timing that the UE resets one or more MAC entities. The one or more RRC parameters may include a timer value related to the condition, a measurement configuration related to the condition and/or a measurement identity to identify the condition. The RRC message may be sent by the gNB on a dedicated control channel (DCCH) logical channel.

In addition, further relaxing network control may be considered. Since a context fetch procedure may be available in NR, UE based target cell determination may have benefits to relax network based mobility. However, if UE is allowed to select the target cell among candidate cells, HO command may need to include system information corresponding to candidate cells. Alternatively it may be possible that UE acquires minimum system information (SI) based on a cell selection/reselection procedure. The UE may be required to have an additional receiver or gap configuration to get other cell's system information.

In one implementation, the UE may receive, from the gNB, a RRC message including one or more RRC parameters. The one or more RRC parameters may include parameters related to a cell reselection. The RRC message may be sent by the gNB on a dedicated control channel (DCCH) logical channel. The gNB may also broadcast parameters related to a cell reselection but it may be independent parameters from parameters related a cell reselection sent by using the DCCH logical channel. In response to receive the RRC message, the UE may initiate a cell reselection procedure in the RRC_CONNECTED state. In RRC_IDLE, the cell reselection procedure is performed. The UE may determine a target cell and/or a timing of access to the target cell. The cell reselection procedure in RRC_CONNECTED may be performed while the UE monitors a radio link in a serving cell (e.g., PCell, PSCell), receives data on the serving cell, and/or transmits data on the serving cell. The RRC message may include mobility control information. The parameters related to a cell reselection may be included in the mobility control information.

The cell selection criterion S is fulfilled when:

Srxlev>0 AND Squal>0

where:

Srxlev−Qᵣₓₗₑᵥₘₑₐₛ−(Qᵣₓₗₑᵥₘᵢₙ+Q_{rxlevminoffset})−Pcompensation Squal=Q_{qualmeas}−(Q_{qualmin}+Q_{qualminoffset})

where

| | |
|---|---|
| Srxlev | Cell selection RX level value (dB) |
| Squal | Cell selection quality value (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm) |
| Q_{qualmin} | Minimum required quality level in the cell (dB) |
| Q_{rxlevminoffset} | Offset to the signalled Qᵣₓₗₑᵥₘᵢₙ |
| | taken into account in the Srxlev evaluation as a result of |
| | a periodic search for a higher priority PLMN while |
| | camped normally In a VPLMN |
| Q_{qualminoffset} | Offset to the signalled Q_{qualmin} |
| | taken into account in the Squal evaluation as a result of |
| | a periodic search for a higher priority PLMN while |
| | camped normally in a VPLMN |
| Pcompensation | max(P_{EMAX} − P_{PowerClass}, 0) (dB) |
| P_{EMAX} | Maximum TX power level an UE may use when |
| | transmitting on the uplink in the cell (dBm) defined as |
| | P_{EMAX} in [TS 36.101] |
| P_{PowerClass} | Maximum RF output power of the UE (dBm) according |
| | to the UE power class |

The cell-ranking criterion Rs for serving cell and Rn for neighbouring cells may be defined by:

Rₛ=Q_{meas,s}+Q_{Hyst}

Rₙ=Q_{meas,n}−Qoffset

, where Qmeas may be Reference Signal Reception Power (RSRP) measurement quantity

used in cell reselections. Qoffset may for intra-frequency: equal to Qoffsets,n, if offsets,n is valid, otherwise equal to zero. The UE may perform ranking of cells that fulfill the cell selection criterion S. The cells may be ranked according to the R criteria specified above, deriving Qmeas,n and Qmeas,s and calculating the R values using averaged RSRP results.

If a cell is ranked as the best cell the UE may perform cell reselection to that cell. If this cell is found to be not-suitable, the UE may behave according to a procedure for Cells with cell reservations, access restrictions or unsuitable for normal camping.

The UE may reselect the new cell, only if the following conditions are met:
the new cell is better ranked than the serving cell during a time interval Treselection_{RAT};
more than 1 second has elapsed since the UE camped on the current serving cell.

In RRC_CONNECTED, the UE may determine the target cell based on the result of the cell reselection and may start a timer related to a handover failure (e.g., T304), start synchronizing to the downlink of the target cell, and/or reset one or more MAC entities

The above cell reselection related parameters, rule, criteria, and/or condition may be included in a measurement procedure for RRC_CONNECTED.

Cell reselection parameters may be broadcast in system information or sent by the RRC message on a DCCH logical channel. One or more of the following cell reselection parameters may be defined:

cellReselectionPriority
This specifies the absolute priority for NR (e.g., 5G-RAN) frequency or EUTRAN frequency or UTRAN frequency or group of GERAN frequencies or band class of CDIVIA2000 HRPD or band class of CDMA2000 1×RTT.

Qoffset_{s,n}
This specifies the offset between the two cells.

Qoffset_{frequency}
Frequency specific offset for equal priority NR frequencies.

Q_{hyst}
This specifies the hysteresis value for ranking criteria.

Q_{qualmin}
This specifies the minimumrequired quality level in the cell in dB.

Qᵣₓₗₑᵥₘᵢₙ
This specifies the minimum required Rx level in the cell in dBm.

Treselection_{RAT}
This specifies the cell reselection timer value. For each target NR frequency and for each RAT (other than E-UTRA) a specific value for the cell reselection timer is defined, which is applicable when evaluating reselection within NRor towards other RAT (i.e. Treselection_{RAT} for NR is Treselection_{EUTRA}, for UTRAN Treselection_{UTRA} for GERAN Treselection_{GERA}, for Treselection_{CDMA_HRPD}, and for Treselection_{CDMA_1×RTT}).

Treselection_{NR}
This specifies the cell reselection timer value Treselection_{RAT} for NR. The parameter can be set per NR frequency.

Treselection_{EUTRA}
This specifies the cell reselection timer value Treselection_{RAT} for E-UTRAN. The parameter can be set per E-UTRAN frequency [3].

Treselection_{UTRA}
This specifies the cell reselection timer value Treselection_{RAT} for UTRAN.

Treselection_{GERA}
This specifies the cell reselection timer value Treselection_{RAT} for GERAN.

Treselection_{CDMA_HRPD}
This specifies the cell reselection timer value Treselection_{RAT} for CDMA HRPD.

Treselection_{CDMA_1×RTT}
This specifies the cell reselection timer value Treselection_{RAT} for CDMA 1×RTT.

Thresh_{X, HighP}
This specifies the Srxlev threshold (in dB) used by the UE when reselecting towards a higher priority RAT/frequency than the current serving frequency. Each frequency of E-UTRAN and UTRAN, each group of GERAN frequencies, each band class of CDMA2000 MUD and CDMA2000 1×RTT might have a specific threshold.

Thresh_{X, HighQ}
This specifies the Squal threshold (in dB) used by the UE when reselecting towards a higher priority RAT/frequency than the current serving frequency.

Thresh_{X, LowP}
This specifies the Srxlev threshold (in dB) used by the UE when reselecting towards a lower priority RAT/frequency than the current serving frequency.

Thresh_{X, LowQ}
This specifies the Squal threshold (in dB) used by the TIE when reselecting towards a lower priority RAT/frequency than the current serving frequency.

Thresh_{Serving, LowP}
This specifies the Srxlev threshold (in dB) used by the UE on the serving cell when reselecting towards a lower priority RAT/frequency.

Thresh_{Serving, LowQ}
This specifies the Squal threshold (in dB) used by the UE on the serving cell when reselecting towards a lower priority RAT/frequency.

S_{IntraSearchQ}
This specifies the Srxlev threshold (in dB) for intra-frequency measurements.

S_{IntraSearcbQ}
This specifies the Squal threshold (in dB) for intra-frequency measurements.

S_{nonIntraSearchP}
This specifies the Srxlev threshold (in dB) for NR inter-frequency and inter-RAT measurements.

S_{nonIntraSearchQ}
This specifies the Squal threshold (in dB) for NR inter-frequency and inter-RAT measurements.

To support UE based determination of a target cell or access timing to the target, data forwarding timing may also be taken into consideration. In normal handover procedure, data forwarding from the source cell to the target cell may start at the gNB transmitting the HO command to the UE. If context fetch is used, it may be possible to start data forwarding at a timing of context fetch. In this procedure, some data packet in source cell may be lost and data delivery at target cell may be delayed, but source cell may not need to forward data until UE accesses to the target.

In normal handover, at a preparation phase, a source gNB may negotiate with a target gNB and the target gNB may perform a admission control before HO command is delivered to the UE. If the network supports UE based determination of a target cell, the admission control may need to be done at access to the target by acquiring system information directly from the target. This may have some benefit to reduce negotiations between gNBs.

A normal HO command complete message (i.e., RRC Connection Reconfiguration Complete message) does not need to include UE identity or gNB identity because the target cell is prepared and knows the source cell. However, Resuming complete message or Re-establishment request message needs to include UE identity in a source cell, source cell identity, and/or source gNB identity in the message because the target cell does not know the source cell and the target cell does not have a UE context. To support UE based determination of a target cell, a type of Resuming complete/Reestablishment request message may be needed. In one implementation, the UE may determine the target cell, start synchronizing to the downlink of the target cell and generate a RRC message including a Cell-Radio Network Temporary Identifier (CRNTI) used in the source cell and/or a physical cell identity of the source cell and submit it to the lower layer to transmit it in the target cell to the gNB.

This can also be applied to a secondary cell group (SCG) change operation in dual connectivity scenario. Relaxing network control for SCG mobility may be efficient. Especially for small cell deployment and multiple transmission points deployment scenario but not limited to, UE controlled mobility may have benefit on interruption time and overhead of measurement. In one implementation, the RRC message may include mobility control information for the SCG. The parameters related to a cell reselection may be included in the RRC message including the mobility control information for the SCG. The parameters related to a cell reselection may be included in the mobility control information for SCG. In response to the RRC message, the UE may initiate a cell reselection procedure for the SCG or the PSCell in the RRC_CONNECTED state. The UE may determine the target PSCell (or the target SCG), start synchronizing to the downlink of the target PSCell and generate a RRC message including a Cell-Radio Network Temporary Identifier (C-RNTI) used in the source PSCell and/or a physical cell identity of the source PSCell and submit it to the lower layer to transmit it to the gNB.

Each of the one or more UEs 102 may include one or more transceivers 118, one or more demodulators 114, one or more decoders 108, one or more encoders 150, one or more modulators 154, one or more data buffers 104 and one or more UE operations modules 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals (e.g., downlink channels, downlink signals) from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals (e.g., uplink channels, uplink signals) to the gNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more gNBs 160. The UE operations module 124 may include a UE RRC information configuration module 126. The UE operations module 124 may include a UE mobility control module 128. In some implementations, the UE operations module 124 may include physical (PHY) entities, Medium Access Control (MAC) entities, Radio Link Control (RLC) entities, packet data convergence protocol (PDCP) entities, and an Radio Resource Control (RRC) entity.

The UE operations module 124 may provide the benefit of performing NR mobility efficiently.

The UE operations module 124 may provide information 148 to the one or more receivers 120. For example, the UE operations module 124 may inform the receiver(s) 120 when or when not to receive transmissions based on the Radio Resource Control (RRC) message (e.g, broadcasted system information, RRC connection reconfiguration message), MAC control element, and/or the DCI (Downlink Control Information).

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. The one or more transmitters 158 may upconvert and transmit the modulated signal(s) 156 to one or more gNBs 160.

The gNB 160 may include one or more transceivers 176, one or more demodulators 172, one or more decoders 166, one or more encoders 109, one or more modulators 113, one or more data buffers 162 and one or more gNB operations modules 182. For example, one or more reception and/or transmission paths may be implemented in a gNB 160. For convenience, only a single transceiver 176, decoder 166, demodulator 172, encoder 109 and modulator 113 are illustrated in the gNB 60, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals (e.g., uplink channels, uplink signals) from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals (e.g., downlink channels, downlink signals) to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first gNB-decoded signal 164 may comprise received payload data, which may be stored in a data buffer 162. A second gNB-decoded signal 168 may comprise overhead data and/or control data. For example, the second gNB-decoded signal 168 may provide data (e.g., PUSCH transmission data) that may be used by the gNB operations module 182 to perform one or more operations.

In general, the gNB operations module 182 may enable the gNB 160 to communicate with the one or more UEs 102. The gNB operations module 182 may include a gNB RRC information configuration module 194. The gNB operations module 182 may include a gNB mobility control module 196. The gNB operations module 182 may include PHY entities, MAC entities, RLC entities, PDCP entities, and an RRC entity.

The gNB operations module 182 may provide the benefit of performing NR mobility efficiently.

The gNB operations module 182 may provide information 190 to the one or more receivers 178. For example, the gNB operations module 182 may inform the receiver(s) 178 when or when not to receive transmissions based on the RRC message (e.g, broadcasted system information, RRC connection reconfiguration message), MAC control element, and/or the DCI (Downlink Control Information).

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode transmission data 105 and/or other information 101.

In general, the gNB operations module 182 may enable the gNB 160 to communicate with one or more network nodes (e.g., a NG mobility management function, a NG core UP functions, a mobility management entity (MME), serving gateway (S-GW), gNBs). The gNB operations module 182 may also generate a RRC connection reconfiguration message to be signaled to the UE 102.

The encoder 109 may encode transmission data 105 and/or other information 101 provided by the gNB operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that one or more of the elements or parts thereof included in the gNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

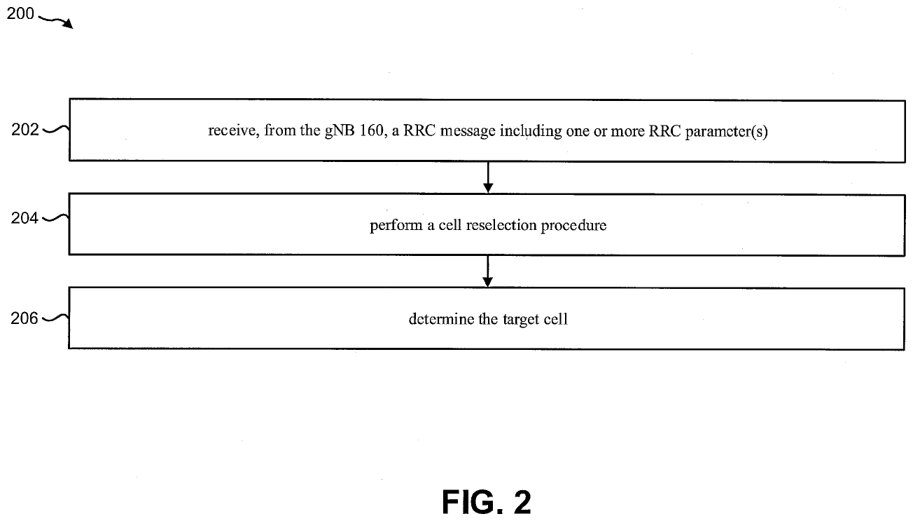

FIG. 2 is a flow diagram illustrating one implementation of a method 200 for NR mobility by a UE 102.

The UE 102 may receive 202, from the gNB 160, a RRC message including one or more RRC parameter(s). The RRC parameter(s) may be included in a System Information Block or a dedicated RRC message. The one or more RRC parameters include parameters related to a cell reselection, and the RRC message is sent on a dedicated control channel (DCCH) logical channel. The UE may perform 204 a cell reselection procedure in response to receive the one or more RRC parameters. Additionally or alternatively, the UE may 206 determine the target cell (e.g., target PCell, target PSCell). Additionally or alternatively, the UE may 208 start synchronizing to the downlink of the target cell (e.g., target PCell, target PSCell). Additionally or alternatively, the UE may 210 generate a RRC message including a Cell-Radio Network Temporary Identifier (C-RNTI) used in the source cell (e.g., source PCell, source PSCell) and/or a physical cell identity of the source cell (e.g., source PCell, source PSCell). Additionally or alternatively, the UE may 212 submit the RRC message including the C-RNTI and/or the physical cell identity to the lower layer to transmit it to the gNB.

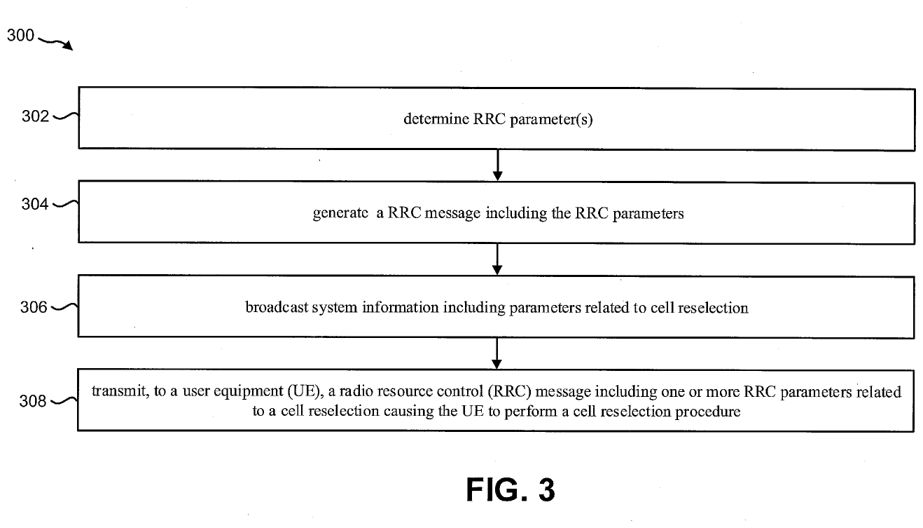

FIG. 3 is a flow diagram illustrating one implementation of a method 300 for NR mobility by a gNB 160.

The gNB 160 may determine 302 RRC parameter(s). The gNB 160 may generate 304 a RRC message including the RRC parameters. The RRC parameter(s) may be included in a System Information Block or a dedicated RRC message. The one or more RRC parameters may include parameters related to a cell reselection, and the RRC message may be sent on a dedicated control channel (DCCH) logical channel. The gNB 160 may 306 broadcast system information including parameters related to cell reselection, The gNB 160 may 308 transmit, to a user equipment (UE), a radio resource control (RRC) message including one or more RRC parameters related to a cell reselection. The one or more RRC parameter may cause the UE 102 to perform a cell reselection procedure.

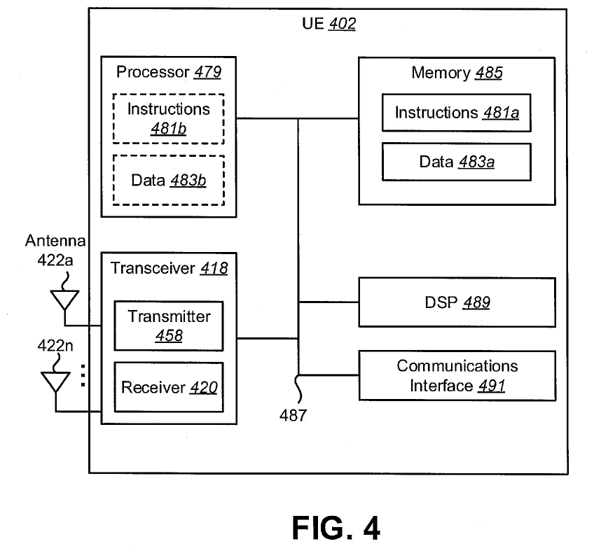

FIG. 4 illustrates various components that may be utilized in a UE 402. The UE 402 described in connection with FIG. 4 may be implemented in accordance with the UE 102 described in connection with FIG. 1. The UE 402 includes a processor 481 that controls operation of the UE 402. The processor 481 may also be referred to as a central processing unit (CPU). Memory 487, which may include read-only memory (ROM), random access memory (RAM), a combination of the two or any type of device that may store information, provides instructions 483a and data 485a to the processor 481. A portion of the memory 487 may also include non-volatile random access memory (NVRAM). Instructions 483b and data 485b may also reside in the processor 481. Instructions 483b and/or data 485b loaded into the processor 481 may also include instructions 483a and/or data 485a from memory 487 that were loaded for execution or processing by the processor 481. The instructions 483b may be executed by the processor 481 to implement one or more of the methods 200 described above.

The UE 402 may also include a housing that contains one or more transmitters 458 and one or more receivers 420 to allow transmission and reception of data. The transmitter(s) 458 and receiver(s) 420 may be combined into one or more transceivers 418. One or more antennas 422a-n are attached to the housing and electrically coupled to the transceiver 418.

The various components of the UE 402 are coupled together by a bus system 489, which may include a power bus, a control signal bus and a status signal bus, in addition to a data bus. However, for the sake of clarity, the various buses are illustrated in FIG. 4 as the bus system 489. The UE 402 may also include a digital signal processor (DSP) 491 for use in processing signals. The UE 402 may also include a communications interface 493 that provides user access to the functions of the UE 402. The UE 402 illustrated in FIG. 4 is a functional block diagram rather than a listing of specific components.

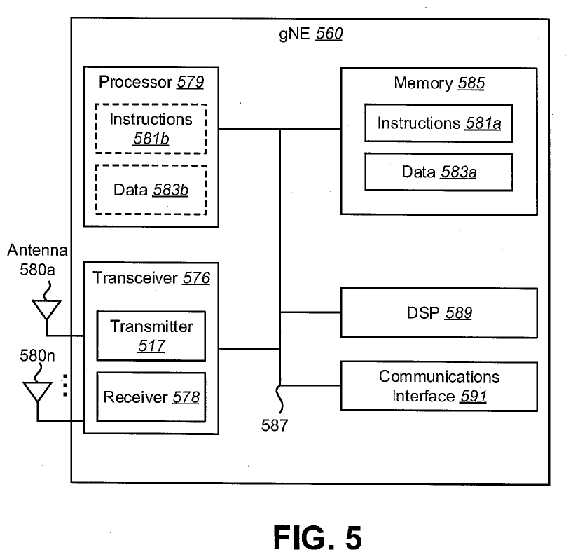

FIG. 5 illustrates various components that may be utilized in a gNB 560. The gNB 560 described in connection with FIG. 5 may be implemented in accordance with the gNB 160 described in connection with FIG. 1. The gNB 560 includes a processor 581 that controls operation of the gNB 560. The processor 581 may also be referred to as a central processing unit (CPU). Memory 587, which may include read-only memory (ROM), random access memory (RAM), a combination of the two or any type of device that may store information, provides instructions 583a and data 585a to the processor 581. A portion of the memory 587 may also include non-volatile random access memory (NVRAM). Instructions 583b and data 585b may also reside in the processor 581. Instructions 583b and/or data 585b loaded into the processor 581 may also include instructions 583a and/or data 585a from memory 587 that were loaded for execution or processing by the processor 581. The instructions 583b may be executed by the processor 581 to implement one or more of the methods 300 described above.

The gNB 560 may also include a housing that contains one or more transmitters 517 and one or more receivers 578 to allow transmission and reception of data. The transmitter(s) 517 and receiver(s) 578 may be combined into one or more transceivers 576. One or more antennas 580a-n are attached to the housing and electrically coupled to the transceiver 576.

The various components of the gNB 560 are coupled together by a bus system 589, which may include a power bus, a control signal bus and a status signal bus, in addition to a data bus. However, for the sake of clarity, the various buses are illustrated in FIG. 5 as the bus system 589. The gNB 560 may also include a digital signal processor (DSP) 591 for use in processing signals. The gNB 560 may also include a communications interface 593 that provides user access to the functions of the gNB 560. The gNB 560 illustrated in FIG. 5 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is nontransitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray (registered trademark) disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

What is claimed is:

1. A method by a user equipment (UE), comprising:
receiving, from a base station, a radio resource control (RRC) message including one or more RRC parameters, wherein the one or more RRC parameters include parameters related to a cell reselection, and the RRC message is sent on a dedicated control channel (DCCH) logical channel; and
performing a cell reselection procedure in response to receive the one or more RRC parameters.

2. A method by a base station, comprising:
broadcasting system information including parameters related to a cell reselection; and
transmitting, to a user equipment (UE), a radio resource control (RRC) message including one or more RRC parameters,
wherein the one or more RRC parameters include parameters related to a cell reselection; the RRC message is sent on a dedicated control channel (DCCH) logical channel, and the one or more RRC parameter causes the UE to perform a cell reselection procedure.

3. A user equipment (UE), comprising:
a processor; and
memory in electronic communication with the processor, wherein instructions stored in the memory are executable to receive, from a base station, a radio resource control (RRC) message including one or more RRC parameters, wherein the one or more RRC parameters include parameters related to a cell reselection; the RRC message is sent on a dedicated control channel (DCCH) logical channel; and
perform a cell reselection procedure in response to receive the one or more RRC parameters.

4. A base station, comprising:
a processor; and
memory in electronic communication with the processor, wherein instructions stored in the memory are executable to:
broadcast system information including parameters related to a cell reselection; and
transmit, to a user equipment (UE), a radio resource control (RRC) message including one or more RRC parameters,
wherein the one or more RRC parameters include parameters related to a cell reselection; the RRC message is sent on a dedicated control channel (DCCH) logical channel, and the one or more RRC parameter causes the UE to perform a cell reselection procedure.
